(19) United States
(12) Patent Application Publication
(10) Pub. No.: US 2008/0129547 A1
(43) Pub. Date: Jun. 5, 2008

(54) Vehicle emergency call device and vehicle emergency call system

(75) Inventor: Kouji Shinoda, Farmington Hills, MI (US)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/982,032

(22) Filed: Nov. 1, 2007

(30) Foreign Application Priority Data
Nov. 2, 2006 (JP) 2006-299183

(51) Int. Cl. G08G 1/123

(52) U.S. Cl. 340/991

(57) ABSTRACT

A vehicle emergency call device includes a position information receiving unit, a positioning unit, a position information storing unit, and a control unit. The position information receiving unit obtains first position information from a navigation system. The positioning unit obtains second position information by performing computation using positioning assist information received from a GPS satellite. The control unit causes the positioning unit to receive the positioning assist information while the navigation system is activated. The control unit causes the position information storing unit to store one of the first and second position information sets. The control unit transmits the one of the first and second position information sets stored in the position information storing unit through a transmitting unit to a service center for use as an emergency call when a start trigger for starting an emergency call occurs.

### CROSS REFERENCE TO RELATED APPLICATION

This application is based on and incorporates herein by reference Japanese Patent Application No. 2006-299183 filed on Nov. 2, 2006.

### BACKGROUND OF THE INVENTION

1. Field of the Invention

The present invention relates to a vehicle emergency call device that transmits position information to a service center for use as an emergency call when a start trigger for starting an emergency call occurs. Also, the present invention relates to a vehicle emergency call system that includes the vehicle emergency call device and a navigation system.

2. Description of Related Art

For example, JP-A-2001-043469 describes a vehicle emergency call device that receives and obtains position information from a navigation system to store the position information therein. The vehicle emergency call device, for example, transmits the stored position information to a service center for use as an emergency call when a start trigger for starting an emergency call occurs (e.g., when an accident happens).

However, in the configuration where the position information is received from the navigation system, for example, if malfunction of the navigation system or a communication line occurs, an appropriate vehicle position may not be reported to the service center disadvantageously. This is because even when the start trigger for starting the emergency call is generated (occurs), new position information that is positioned (measured) at a later (or latest) time cannot be transmitted to the service center because the above malfunction makes it impossible to obtain the position information from the navigation system.

### SUMMARY OF THE INVENTION

The present invention is made in view of the above disadvantages. Thus, it is an objective of the present invention to address at least one of the above disadvantages.

To achieve the objective of the present invention, there is provided a vehicle emergency call device, which includes a position information receiving unit, a positioning unit, a position information storing unit, and a control unit. The position information receiving unit receives and obtains first position information from a navigation system. The positioning unit obtains second position information by performing computation using positioning assist information received from a global positioning system satellite. The control unit causes the positioning unit to receive the positioning assist information from the global positioning system satellite to obtain the second position information while the navigation system is activated. The control unit causes the position information storing unit to store one of the first position information and the second position information. The control unit transmits the one of the first position information and the second position information stored in the position information storing unit through a transmitting unit to a service center for use as an emergency call when a start trigger for starting an emergency call occurs.

To achieve the objective of the present invention, there is also provided a vehicle emergency call system, which includes the above vehicle emergency call device and the above navigation system that transmits the first position information to the vehicle emergency call device.

To achieve the objective of the present invention, there is also provided a vehicle emergency call device, which includes a position information receiving unit, a positioning unit, a position information storing unit, and a control unit. The position information receiving unit receives and obtains first position information from a navigation system. The positioning unit obtains second position information by performing computation using positioning assist information received from a global positioning system satellite. The control unit causes the positioning unit to receive the positioning assist information from the global positioning system satellite and to store the positioning assist information while the navigation system is activated. If an obtainable state, where the position information receiving unit is able to obtain the first position information, is changed into a non-obtainable state, where the position information receiving unit is disabled to obtain the first position information, while the navigation system is activated, the control unit causes the positioning unit to perform the computation using the stored positioning assist information to obtain the second position information. If the non-obtainable state is changed into the obtainable state while the navigation system is activated, the control unit prohibits the positioning unit from performing the computation using the stored positioning assist information. The control unit causes the position information storing unit to store one of the first position information and the second position information. The control unit transmits the one of the first position information and the second position information stored in the position information storing unit through a transmitting unit to a service center for use as an emergency call when a start trigger for starting the emergency call occurs.

To achieve the objective of the present invention, there is also provided a vehicle emergency call system, which includes the above vehicle emergency call and the above navigation system that transmits the first position information to the vehicle emergency call device.

### BRIEF DESCRIPTION OF THE DRAWINGS

The invention, together with additional objectives, features and advantages thereof, will be best understood from the following description, the appended claims and the accompanying drawings in which:

FIG. 1 is function block diagram according to a first embodiment of the present invention;

FIG. 2 is a flow chart of a vehicle emergency call of the first embodiment;

FIG. 3 is a schematic diagram showing an example of storing position information;

FIG. 4 is a function block diagram according to a second embodiment of the present invention; and

FIG. 5 is a flow chart of the second embodiment corresponding to FIG. 2.

### DETAILED DESCRIPTION OF PREFERRED EMBODIMENTS

### First Embodiment

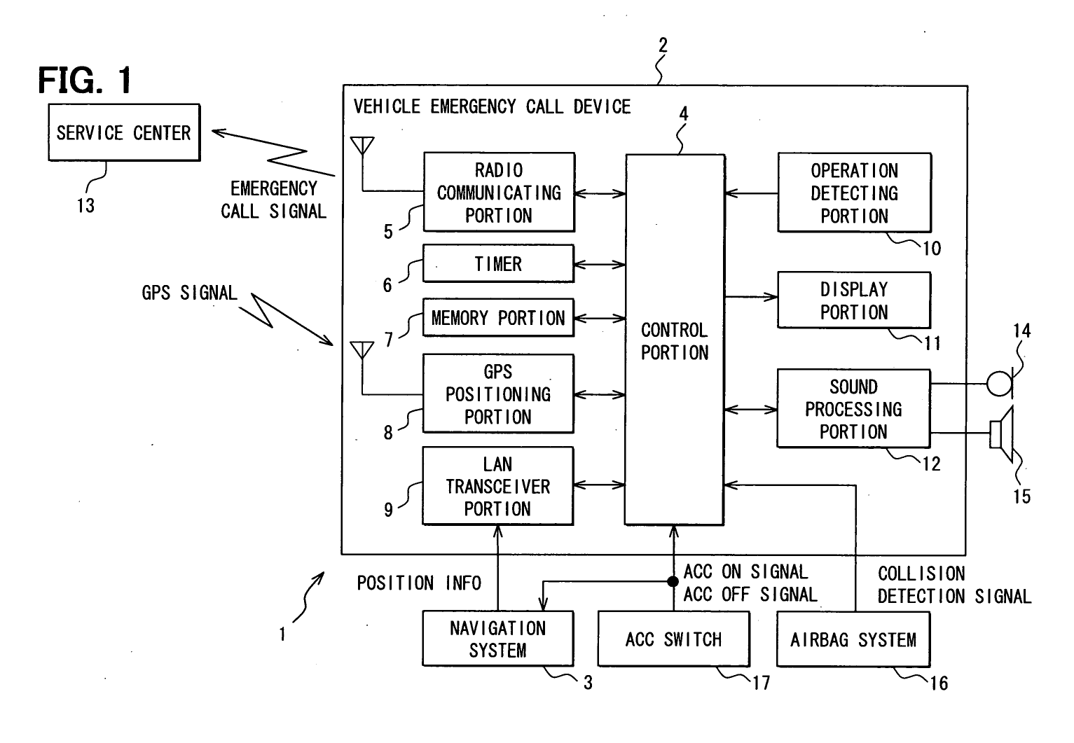

The first embodiment of the present invention is described below referring to FIG. 1 through FIG. 3. A vehicle emergency call system 1 includes a vehicle emergency call device 2 and a navigation system 3. The vehicle emergency call device 2 includes a control portion 4 (control unit of the present invention), a radio communicating portion 5 (transmitting unit of the present invention), a timer 6, a memory portion 7 (position information storing unit of the present invention), a global positioning system (GPS) positioning portion 8 (positioning unit of the present invention), a LAN transceiver portion 9 (position information receiving unit of the present invention), an operation detecting portion 10, a display portion 11, and a sound processing portion 12.

The control portion 4 is mainly made of a CPU, and controls general operations of the vehicle emergency call device 2. When the radio communicating portion 5 receives an emergency call command signal from the control portion 4, the radio communicating portion 5 transmits an emergency call signal to a service center 13 via a radio communication net. In the present case, the emergency call signal includes various information sets, such as device identification for identifying the vehicle emergency call device 2, position information for indicating a vehicle position.

When the timer 6 receives a time command signal from the control portion 4, the timer 6 times. When the GPS positioning portion 8 receives a positioning command signal from the control portion 4, the GPS positioning portion 8 receives a GPS signal transmitted from a global positioning system satellite (GPS satellite). Then, the GPS positioning portion 8 extracts positioning assist information (e.g. almanac data, ephemeris data) from the GPS signal, the positioning assist information being required to obtain position information. Then, the GPS positioning portion 8 performs computation using the positioning assist information to regularly obtain the position information (latitude, longitude). For example, the position information is obtained every one second.

The LAN transceiver portion 9 has an interface structure interfering with an on-vehicle LAN, and in the present embodiment, the LAN transceiver portion 9 receives and transmits various information sets with the navigation system 3. When the navigation system 3 is normally activated, the LAN transceiver portion 9 regularly receives and obtains the position information (latitude, longitude) from the navigation system 3. For example, the LAN transceiver portion 9 receives the position information every one second. In the present case, if position information (first position information) that the LAN transceiver portion 9 receives from the navigation system 3 is compared with position information (second position information) that the GPS positioning portion 8 obtains through positioning (through computation using the positioning assist information), it is known that the former information has a higher accuracy than the latter information. Here, the former position information has the higher accuracy than the latter position information because the former position information is associated with a vehicle speed signal and with a gyro detection result and because the former position information is corrected based on a map matching process. Also, the LAN transceiver portion 9 receives and obtains the position information from the navigation system 3 and receives and obtains information about a running speed and a travel distance from the navigation system 3 when the navigation system 3 is normally activated.

The memory portion 7 stores various information sets and stores in time-series the above position information sets that are received by the LAN transceiver portion 9 from the navigation system 3 and the position information sets that are positioned and obtained by the GPS positioning portion 8. In the present case, the control portion 4 causes the memory portion 7 to store a predetermined number (for example, 10 sets) of position information sets. Here, the predetermined number of the position information sets is typically counted from the latest to the past. If the predetermined number of position information sets have been already stored at a time when the control portion 4 causes the memory portion 7 to store the latest position information, the oldest one of the stored position information sets by the predetermined number is deleted and the latest position information is stored, instead.

When a user operates an emergency call button, the operation detecting portion 10 outputs an operation detection signal to the control portion 4. When the display portion 11 receives a display command signal from the control portion 4, the display portion 11 displays display information in accordance with the display command signal. The sound processing portion 12 processes a transmitter sound that is inputted through the microphone 14, and processes a receiver sound that is outputted through the speaker 15. In the present case, when the vehicle emergency call device 2 is communicated with the service center 13 by a telephone circuit, the user (occupant of the vehicle) is able to perform audio communication (talk) with an operator at the service center 13 by using the microphone 14 and the speaker 15. Thus, the user can orally request help and report a condition of an accident.

An air bag system 16 detects a collision of a vehicle, and when an impact by the collision has a predetermined level, the air bag system 16 outputs a collision detection signal to the control portion 4. In the present case, the control portion 4 performs an emergency call operation upon a start trigger for starting the emergency call. Here, the start trigger is either an input of the operation detection signal from the operation detecting portion 10 through the operation of the emergency call button by the user, or the input of the collision detection signal from the air bag system 16.

An accessory (ACC) switch 17 outputs an ACC ON signal and an ACC OFF signal to the control portion 4. Here, the ACC ON signal and the ACC OFF signal indicate an operational state (ON/OFF) of the switch. In the present case, when the control portion 4 receives the ACC ON signal from the ACC switch 17, the control portion 4 operates the vehicle emergency call device 2 in a normal mode, and causes the LAN transceiver portion 9 to regularly receive the position information from the navigation system 3. Also, the control portion 4 outputs the positioning command signal to the GPS positioning portion 8 to activate the GPS positioning portion 8 such that the GPS positioning portion 8 is caused to receive the GPS signal to regularly obtain the position information.

Also, when the control portion 4 receives the ACC OFF signal from the ACC switch 17, the control portion 4 operates the vehicle emergency call device 2 in a low power consumption mode, and prohibits the LAN transceiver portion 9 from receiving the position information from the navigation system 3. In contrast, the control portion 4 outputs the positioning command signal to the GPS positioning portion 8 for use as a theft tracking, for example, when a start trigger for starting the theft tracking is generated. In the present case, the control portion 4 makes the memory portion 7 store the position information positioned and obtained by the GPS positioning portion 8, and makes the radio communicating portion 5 transmit the position information to an exterior.

In the above structure the vehicle emergency call device 2 is connected with the navigation system 3 via the on-vehicle LAN. However, the vehicle emergency call device 2 may be alternatively connected with the navigation system 3 via an USB connection. Also, when the navigation system 3 receives the ACC ON signal from the ACC switch 17, the navigation system 3 is activated, and when the navigation system 3 receives the ACC OFF signal from the ACC switch 17, the navigation system 3 is stopped.

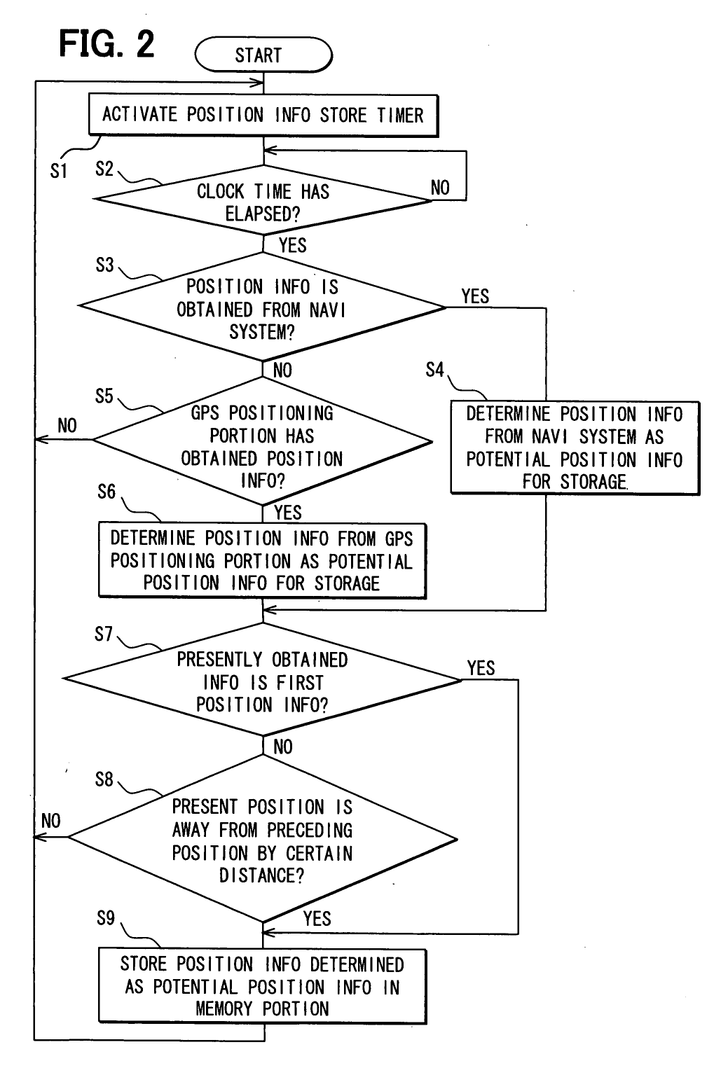

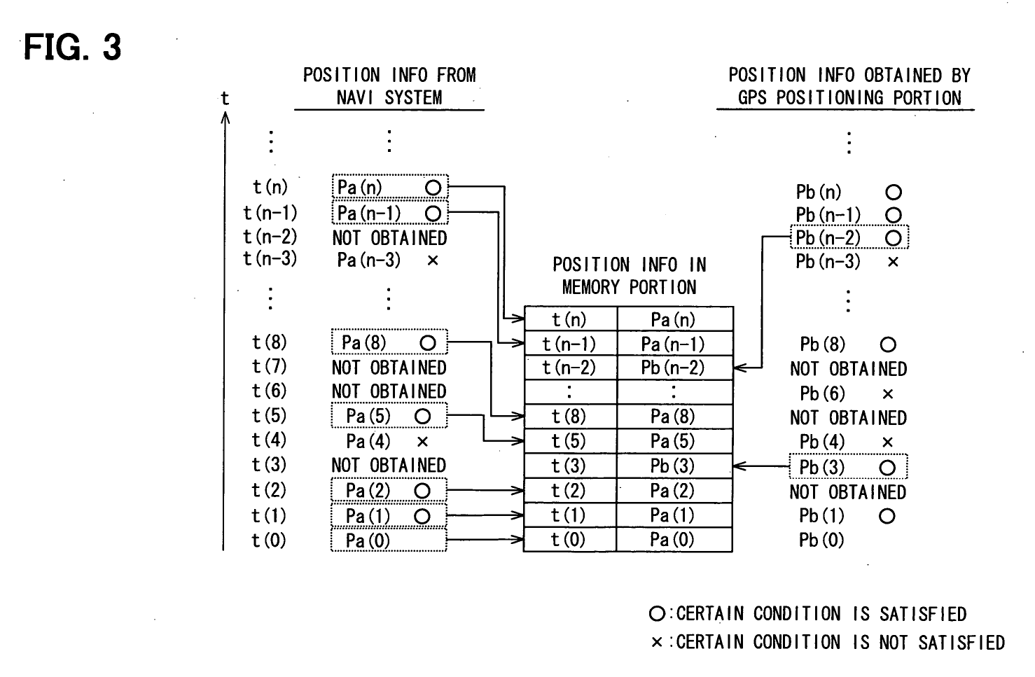

Next, an operation of the above structure is described with reference to FIG. 2 and FIG. 3.

When the control portion 4 receives the ACC ON signal from the ACC switch 17 to activate the vehicle emergency call device 2 in the normal mode, a position information store timer is activated by the timer 6 (step S1), and it is determined at step S2 whether or not a clock time of the position information store timer has elapsed (whether or not time is up). In the present case, the clock time of the position information store timer is an interval (e.g., one second) that corresponds to a reception interval by which the position information is regularly received from the navigation system 3, and also to a positioning interval by which the GPS positioning portion 8 regularly positions. Then, when the control portion 4 detects that the clock time of the clock time position information store timer has elapsed (YES at step S2), it is determined at step S3 whether the control portion 4 has received and obtained the position information from the navigation system 3 at the present point.

When the control portion 4 has received and obtained the position information from the navigation system 3 (YES at step S3), the position information received from the navigation system 3 is determined as potential position information for storage at step S4. In contrast, when the control portion 4 has not obtained the position information from the navigation system 3 (NO at step S3), it is determined whether the GPS positioning portion 8 has positioned and obtained position information at the present point (step S5). When the GPS positioning portion 8 has positioned and obtained the position information (YES at step S5), the position information obtained through the positioning by the GPS positioning portion 8 is determined as the potential position information for storage (step S6).

Next, the control portion 4 determines whether the preceding position information is stored in the memory portion 7 (step S7). Here, the preceding position information is the latest position information stored in the memory portion 7 at the present point. When the preceding position information is not stored in the memory portion 7, in other words, when it is determined that the presently obtained position information is the first position information to be stored in the memory portion 7 (YES at step S7), the position information that has been determined as the potential position information for storage is stored in the memory portion 7 (step S9). Then, example control returns to the above step S1, and the above process is repeated.

In contrast, when the control portion 4 determines that the preceding position information is stored in the memory portion 7 (NO at step S7), the presently obtained position information is compared with the preceding position information to determine whether the present position is away from the preceding position by a certain distance (for example, equal to or more than 80 m) at step S8. This corresponds to a certain condition of the present embodiment.

When the control portion 4 determines that the present position is away from the preceding position by equal to or more than the certain distance (YES at step S8), the position information that has been determined as the potential position information for storage is stored in the memory portion 7 as the latest position information (step S9). Control returns to the above step S1, and the above process is repeated. In contrast, when the control portion 4 determines that the present position is not away from the preceding position by equal to or more than the certain distance (NO at step S8), the position information that has been determined as the potential position information for storage is not stored in the memory portion 7 as the latest position information. However, control returns to the above step S1, and the above process is repeated.

The control portion 4 executes the above serial process such that as shown in FIG. 3, either one of the position information received from the navigation system 3 and the position information obtained by the GPS positioning portion 8 is stored in the memory portion 7, and the above process is repeated such that at most the predetermined number of the position information sets are stored in time series order. In other words, if the position information has been received and obtained from the navigation system 3 and simultaneously the position information has been positioned (measured) and obtained by the GPS positioning portion 8 at a time when the control portion 4 causes the memory portion 7 to store the position information, and also if the position information obtained from the navigation system 3 indicates a position that is away from the preceding position by equal to or more than the certain distance, the position information obtained from the navigation system 3 is stored in the memory portion 7 (for example, see “Pa(1)”, “Pa(8)”, “Pa(n−1)”, and “Pa(n)”).

Also, if the position information has been received and obtained from the navigation system 3 and simultaneously the GPS positioning portion 8 has not obtained the position information at the time when the control portion 4 causes the memory portion 7 to store the position information, and also if the position information obtained from the navigation system 3 indicates a position that is away from the preceding position by equal to or more than the certain distance, the position information obtained from the navigation system 3 is stored in the memory portion 7 (for example, see “Pa(2)” and “Pa(5)”).

Furthermore, if the GPS positioning portion 8 has positioned and obtained the position information and simultaneously the position information has not obtained from the navigation system 3 at the time when the control portion 4 causes the memory portion 7 to store the position information, and if the position information obtained by the GPS positioning portion 8 indicates a position that is away from the preceding position by equal to or more than the certain distance, the position information obtained by the GPS positioning portion 8 is stored in the memory portion 7 (for example, see “Pb(3)” and “Pb(n−2)”).

The control portion 4 executes a process for storing the position information in the memory portion 7 as above, and also at the same time, executes a process for determining whether the start trigger for starting the emergency call is generated. Thus, the control portion 4 detects one of (a) the input of the operation detection signal from the operation detecting portion 10 through the operation of the emergency call button by the user and (b) the input of the collision detection signal from the air bag system 16. When the control portion 4 detects that the start trigger for starting the emergency call is generated, the control portion 4 causes the position information stored in the memory portion 7 to be transmitted through the radio communicating portion 5 to the service center 13 for use as the emergency call via the radio communication net.

As discussed above, according to the first embodiment, the vehicle emergency call device 2 is configured such that the position information from the navigation system 3 is received and obtained, and simultaneously the GPS positioning portion 8 receives the positioning assist information from the GPS satellite to obtain the position information while the navigation system 3 is activated. For example, even if malfunction of the navigation system 3 or the communication line occurs and thereby it becomes impossible to obtain the position information from the navigation system 3, the position information positioned and obtained by the GPS positioning portion 8 can be continuously stored. Therefore, even if start trigger for starting the emergency call is generated in a situation where it is impossible to obtain the position information from the navigation system 3, the latest position information that is positioned at a latest time can be transmitted to the service center 13. As a result, an appropriate vehicle position can be reported.

Also, in the present embodiment, at the time when the position information is to be stored in the memory portion 7, the position information from the navigation system 3 is received and obtained and simultaneously, the position information is positioned and obtained by the GPS positioning portion 8. In the present case, the position information obtained from the navigation system 3 is stored in the memory portion 7 if the position information obtained from the navigation system 3 indicates a position that is away from the preceding position by equal to or more than the certain distance. As a result, the position information having a high accuracy of positioning can be stored with priority because accuracy for positioning by the navigation system 3 is higher than accuracy of positioning by the GPS positioning portion 8.

A GPS positioning portion is, in general, designed to position and obtain position information for use as other than an emergency call, such as the theft tracking, while the navigation system 3 is off. However, the GPS positioning portion 8 of the present embodiment is designed to also obtain the position information for use as the emergency call in place of the navigation system 3 even when the navigation system 3 is activated, if the malfunction of the navigation system 3 occurs (e.g., if the position information cannot be obtained from the navigation system 3). Thus, the GPS positioning portion 8 can be more effectively utilized.

### Second Embodiment

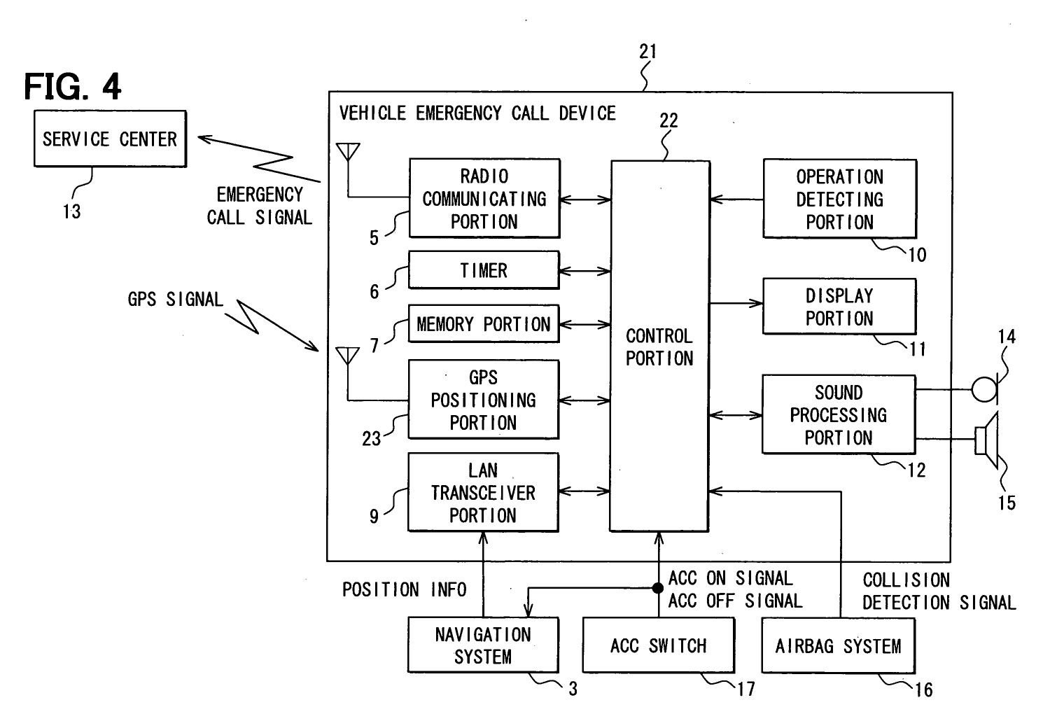

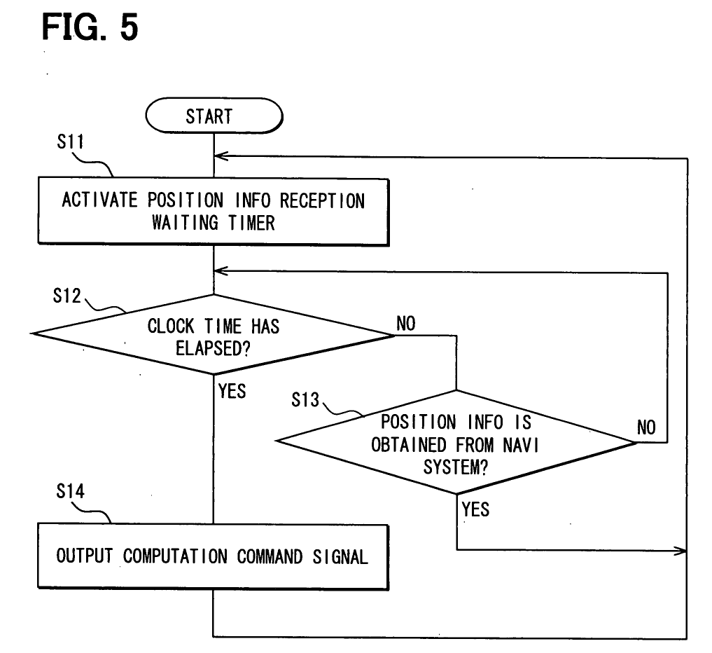

Next, the second embodiment of the present invention is described with reference to FIG. 4 and FIG. 5. It is noted that similar components in the present embodiment similar to the above first embodiment are indicated by the same numeral and explanation thereof is omitted. Different parts different from the first embodiment are mainly described. In the above first embodiment, when the ACC ON signal is inputted from the ACC switch 17, the positioning command signal is outputted to the GPS positioning portion 8 to activate the GPS positioning portion 8. Also, the GPS positioning portion 8 is caused to receive the GPS signal to regularly obtain the position information. In contrast, in the second embodiment, the GPS positioning portion 8 is configured to receive the GPS signal to store the positioning assist information.

In other words, in a vehicle emergency call device 21 of the present embodiment, a control portion 22 outputs a positioning assist information store command signal and a computation command signal in a time-delayed manner in place of the positioning command signal described in the first embodiment. When a GPS positioning portion 23 receives the positioning assist information store command signal from the control portion 22, the GPS positioning portion 23 receives the GPS signal transmitted from the GPS satellite and extracts and stores the positioning assist information from the GPS signal. When the GPS positioning portion 23 receives the computation command signal from the control portion 22, the GPS positioning portion 23 performs computation using the stored positioning assist information to obtain the position information (e.g., latitude, longitude).

In the present case, the control portion 22 executes a process for determining whether the position information is received from the navigation system 3 in parallel with the processes described in the above first embodiment (i.e., the process for storing the position information in the memory portion 7 and the process for determining whether or not the start trigger for starting the emergency call occurs). In other words, in the present case, when the control portion 22 receives the ACC ON signal from the ACC switch 17 to operate the vehicle emergency call device 2 in the normal mode, the control portion 22 outputs the positioning assist information store command signal to the GPS positioning portion 23, and causes the GPS positioning portion 23 to receive the GPS signal and to store the positioning assist information. At the same time, a position information reception waiting timer is activated by the timer 6 (step S11). The control portion 22 determines at step S12 whether or not a clock time of the position information reception waiting timer has elapsed (whether or not time is up). Also, the control portion 22 determines whether or not the LAN transceiver portion 9 has received and obtained the position information from the navigation system 3 (step S13). In the present case, the clock time of the position information reception waiting timer is an interval for waiting for the position information to be received from the navigation system 3, and is an interval for determining whether malfunction of the navigation system 3 or the communication line occurs.

When the control portion 22 determines that the position information has been received from the navigation system 3 before the clock time of the position information reception waiting timer has elapsed (YES at step S13), control returns to step S11, and the above process is repeated.

In contrast, when the control portion 22 detects that the clock time of the position information reception waiting timer has elapsed before the position information has been received from the navigation system 3 (YES at step S12), the control portion 22 determines that the malfunction of the navigation system 3 or the communication line occurs. As a result, the computation command signal is outputted to the GPS positioning portion 23 such that the GPS positioning portion 23 performs computation using the positioning assist information stored at the present point to obtain the position information (step S14).

Along with the above, in the process for storing the position information in the memory portion 7, the control portion 22 determines the position information obtained from the navigation system 3 as the potential position information for storage before the malfunction of the navigation system 3 or the communication line occurs. Then, if the position information determined as the potential position information for storage indicates a position that is away from the preceding position by equal to or more than the certain distance, the position information determined as the potential position information for storage (i.e., the position information obtained from the navigation system 3) is stored in the memory portion 7.

In contrast, the control portion 22 determines the position information positioned and obtained by the GPS positioning portion 8 as the potential position information for storage after the malfunction of the navigation system 3 or the communication line has occurred. Then, if the position information determined as the potential position information for storage indicates a position that is away from the preceding position by equal to or more than the certain distance, the position information determined as the potential position information for storage (i.e., the position information positioned and obtained by the GPS positioning portion 8) is stored in the memory portion 7.

It is noted that in a case where the control portion 22 determines that the malfunction, which has occurred to the navigation system 3 or the communication line, is amended after the control portion 22 has determined that the malfunction of the navigation system 3 or the communication line has occurred, the control portion 22 stops outputting the computation command signal to the GPS positioning portion 23 such that the control portion 22 prohibits the GPS positioning portion 23 from performing the computation using the positioning assist information stored at the present point.

As described above, according to the second embodiment, in the vehicle emergency call device 21, while the navigation system 3 is activated, the position information is obtained from the navigation system 3, and simultaneously the GPS positioning portion 8 receives and stores the positioning assist information from the GPS satellite. In a case, where it becomes impossible to obtain the position information from the navigation system 3 during the activation of the navigation system 3 (i.e., in a case where an obtainable state, where the position information is obtainable, is changed into a non-obtainable state, where the position information is not obtainable), the GPS positioning portion 8 performs the computation using the positioning assist information to obtain the position information. For example, even when the malfunction of the navigation system 3 or the communication line occurs, and thereby it becomes impossible to obtain the position information from the navigation system 3, the position information obtained by the GPS positioning portion 8 can be stored. Thus, similar to the description in the above first embodiment, even when the start trigger for starting the emergency call is generated in the non-obtainable state where the position information can not be obtained from the navigation system 3, the latest position information that is positioned (measured) at a latest time can be transmitted to the service center 13 such that the appropriate vehicle position can be reported to the service center 13.

Also, in the second embodiment, for example, at a point, when the malfunction of the navigation system 3 or the communication line occurs and thereby it becomes impossible to obtain the position information from the navigation system 3, in other words, at a point when the GPS positioning portion 8 is to perform the computation using the positioning assist information, the GPS positioning portion 8 has already stored the positioning assist information. Thus, if the GPS positioning portion 8 has already stored valid almanac data, the position information can be obtained through a warm start (boot). If the GPS positioning portion 8 has stored valid almanac data and valid ephemeris data, the position information can be obtained through a hot start, and thereby required time for obtaining the position information can be minimized. Therefore, the position information can be quickly obtained.

Furthermore, in the second embodiment, the computation using the positioning assist information is performed to obtain the position information, only when, for example, the malfunction of the navigation system 3 or the communication line occurs making it impossible to obtain the position information from the navigation system 3. Thus, the number of occasions for performing the computation using the positioning assist information can be minimized, and therefore, power consumption for the entire of the device can be limited.

### Other Embodiment

The present invention is not limited to the above described embodiments. However, the present invention can be applied as below to other embodiments that is made by modifying or expanding the above embodiments.

The vehicle emergency call device may include part of a navigation system. The vehicle emergency call device may receive other signals as the emergency call trigger other than the collision detection signal from the operation of air bag system or other than the operation detection signal from the operation detecting portion. Here, the operation detection signal is typically made through the operation of the emergency call button by the user.

In order to store the position information in the memory portion, the memory portion may have a first storage region and a second storage region for respective storage. Here, the first storage region stores in time series order the position information received and obtained from the navigation system, and the second storage region stores in time series order the position information positioned and obtained by the GPS positioning portion. When the start trigger for starting the emergency call is generated, the position information stored in either one of the first storage region and the second storage region can be transmitted to the service center. In the present case, alternatively, position information stored in one of the storage regions that stores more position information sets than the other may be transmitted to the service center. Also, alternatively, position information stored in one of the storage regions that stores position information sets having higher continuity than the other may be transmitted to the service center.

Additional advantages and modifications will readily occur to those skilled in the art. The invention in its broader terms is therefore not limited to the specific details, representative apparatus, and illustrative examples shown and described.

What is claimed is:

1. A vehicle emergency call device comprising:
a position information receiving unit for receiving and obtaining first position information from a navigation system;
a positioning unit for obtaining second position information by performing computation using positioning assist information received from a global positioning system satellite;
a position information storing unit; and
a control unit for causing the positioning unit to receive the positioning assist information from the global positioning system satellite to obtain the second position information while the navigation system is activated, wherein:
the control unit causes the position information storing unit to store one of the first position information and the second position information; and
the control unit transmits the one of the first position information and the second position information stored in the position information storing unit through a transmitting unit to a service center for use as an emergency call when a start trigger for starting an emergency call occurs.

2. The vehicle emergency call device according to claim 1, wherein:
if the first position information and the second position information have been simultaneously obtained at a time when the control unit is required to cause the position information storing unit to store the one of the first position information and the second position information, the first position information is stored provided that the first position information satisfies a certain condition.

3. The vehicle emergency call device according to claim 1, wherein:
if the first position information has been obtained and the second position information has not been obtained at a time when the control unit is required to cause the position information storing unit to store the one of the first position information and the second position information, the first position information is stored provided that the first position information satisfies a certain condition.

4. The vehicle emergency call device according to claim 1, wherein:
if the second position information has been obtained and the first position information has not been obtained at a time when the control unit is required to cause the position information storing unit to store the one of the first position information and the second position information, the second position information is stored provided that the second position information satisfies a certain condition.

5. The vehicle emergency call device according to claim 1, wherein:
the positioning unit obtains the second position information for use as other than the emergency call when the navigation system is off.

6. A vehicle emergency call system comprising:
the vehicle emergency call device according to claim 1; and
the navigation system that transmits the first position information to the vehicle emergency call device.

7. A vehicle emergency call device comprising:
a position information receiving unit for receiving and obtaining first position information from a navigation system;
a positioning unit for obtaining second position information by performing computation using positioning assist information received from a global positioning system satellite;
a position information storing unit; and
a control unit for causing the positioning unit to receive the positioning assist information from the global positioning system satellite and to store the positioning assist information while the navigation system is activated, wherein:
if an obtainable state, where the position information receiving unit is able to obtain the first position information, is changed into a non-obtainable state, where the position information receiving unit is disabled to obtain the first position information, while the navigation system is activated, the control unit causes the positioning unit to perform the computation using the stored positioning assist information to obtain the second position information;
if the non-obtainable state is changed into the obtainable state while the navigation system is activated, the control unit prohibits the positioning unit from performing the computation using the stored positioning assist information;
the control unit causes the position information storing unit to store one of the first position information and the second position information; and
the control unit transmits the one of the first position information and the second position information stored in the position information storing unit through a transmitting unit to a service center for use as an emergency call when a start trigger for starting the emergency call occurs.

8. The vehicle emergency call device according to claim 7, wherein:
if the first position information and the second position information have been simultaneously obtained at a time when the control unit is required to cause the position information storing unit to store the one of the first position information and the second position information, the first position information is stored provided that the first position information satisfies a certain condition.

9. The vehicle emergency call device according to claim 7, wherein:
if the first position information has been obtained and the second position information has not been obtained at a time when the control unit is required to cause the position information storing unit to store the one of the first position information and the second position information, the first position information is stored provided that the first position information satisfies a certain condition.

10. The vehicle emergency call device according to claim 7, wherein:
if the second position information has been obtained and the first position information has not been obtained at a time when the control unit is required to cause the position information storing unit to store the one of the first position information and the second position information, the second position information is stored provided that the second position information satisfies a certain condition.

11. The vehicle emergency call device according to claim 7, wherein:
the positioning unit obtains the second position information for use as other than the emergency call when the navigation system is off.

12. A vehicle emergency call system comprising:
the vehicle emergency call device according to claim 7; and
the navigation system that transmits the first position information to the vehicle emergency call device.
